(19) United States
(12) Patent Application Publication
(10) Pub. No.: US 2011/0253414 A1
(43) Pub. Date: Oct. 20, 2011

(54) METAL-CLAD CABLE ASSEMBLY

(75) Inventors: Jeff Dewberry, Carrollton, GA (US); Richard Miller, Carrollton, GA (US); Richard Temblador, Carrollton, GA (US)

(73) Assignee: Southwire Company, Carrollton, GA (US)

(21) Appl. No.: 12/761,063

(22) Filed: Apr. 15, 2010

(51) Int. Cl. H01B 9/02; H01B 19/00

(52) U.S. Cl. 174/102 R; 29/887

(57) ABSTRACT

A metal-clad cable assembly comprising a conductor assembly having a plurality of insulated conductors and a binder disposed around the insulated conductors. The cable assembly further includes an outer metal sheath disposed around the conductor assembly and an electrically conductive grounding foil disposed externally to the conductor assembly, the conductive grounding foil comprising a bottom planar surface and a top planar surface, the bottom planar surface engaging the binder and the top planar surface engaging an interior surface of the metal sheath to form a low impedance equipment ground path.

### BACKGROUND

Metal-clad cables having an interlocked metal sheath potentially provide a low impedance and reliable ground path in order to function as an equipment grounding conductor. Once type of such cable described in U.S. Pat. No. 6,486,395, assigned to the assignee of the present invention, contains a conductor assembly having at least two electrically insulated conductors cabled together longitudinally into a bundle and enclosed within a binder/cover. A bare grounding conductor is cabled externally over the binder/cover, preferably within a trough/interstice formed between the insulated conductors. The metal sheath is helically applied to form an interlocked armor sheath around the conductor assembly, and the bare grounding conductor is adapted to contact the sheath to provide the low impedance ground path.

This design provides significant advantages over other metal clad cables not so constructed. In order to maximize its utility and lowest impedance ground path, it is important that adequate contact be maintained between the bare grounding conductor and the interior surface of the metal sheath. This is particularly challenging due to differing wire gauges and weights that may occur between the insulated conductors and the bare grounding conductor. For example, in the event the bare grounding conductor comprises a low wire gauge (i.e., a large diameter) disposed within an interstice formed by insulated conductors having a high wire gauge (i.e., a small diameter), the bare grounding conductor can lift out from within or otherwise become misaligned within the interstice during manufacturing, and in particular, when twisting the conductor assembly. This can oftentimes cause damage to the cable as the metal sheath is applied. Specifically, when the metal sheath is applied, the armor is pushed against the bare grounding conductor, which can act against and crush one or more of the insulated conductors and also potentially damage the binder/cover. This can result in dielectric failure and eventual waste of materials.

### SUMMARY

In accordance with one aspect of the present invention, a metal-clad cable assembly is provided including a conductor assembly having a plurality of insulated conductors disposed within a non-conductive binder member. The cable assembly further includes an electrically conductive grounding foil, having a top planar surface, a bottom planar surface, and a predetermined thickness, disposed externally to the conductor assembly. An outer metal sheath surrounds the conductor assembly and grounding foil. According to some embodiments, the grounding foil is disposed longitudinally along the length of the metal clad cable. According to other embodiments, the grounding foil is helically wrapped around the conductor assembly. In either configuration, the top planar surface and an inner surface of the metal sheath are in contact with each other to provide a low impedance equipment grounding path.

In accordance with another aspect of the present invention, a method of manufacturing a metal-clad cable assembly is provided. According to some embodiments, the method comprises wrapping a binder around a plurality of conductors forming the conductor assembly, and placing the conductive grounding foil over the conductor assembly. The method further comprises placing a metal sheath around the conductor assembly and contacting the conductive grounding foil to form a low impedance equipment ground path. The grounding foil can be disposed longitudinally over the conductor assembly so as to extend along the length of the metal clad cable or, in the alternative, can be helically wrapped around the conductor assembly. The grounding foil and metal sheath are in contact with each other to provide the low impedance equipment grounding path.

### BRIEF DESCRIPTION OF THE DRAWINGS

FIG. 1 is an illustration of a partial cut-away perspective view of an embodiment of a metal-clad cable assembly in which a grounding foil is employed to advantage;

FIG. 2 is a section view of the metal-clad cable assembly taken along the line 2-2 of FIG. 1;

FIG. 3 is a perspective view of the grounding foil of FIGS. 1 and 2;

FIG. 4 is an illustration of a partial cut-away perspective view of another embodiment of the metal-clad cable assembly of FIGS. 1 and 2;

FIG. 5 is a section view of an alternate embodiment of the metal-clad cable assembly taken along the line 5-5 of FIG. 4;

FIG. 6 is a perspective view of an alternate embodiment of the grounding foil illustrated in FIGS. 1-5;

FIG. 7 is a perspective view of an another embodiment of the grounding foil illustrated in FIGS. 1-5; and

FIG. 7A is a section view of the grounding foil of FIG. 7 taken along the line 7A-7A.

### DETAILED DESCRIPTION

In the description which follows, like parts are marked throughout the specification and drawings with the same reference numerals, respectively. The drawings are not necessarily to scale and certain features may be shown exaggerated in scale or in somewhat schematic form in the interest of clarity and conciseness.

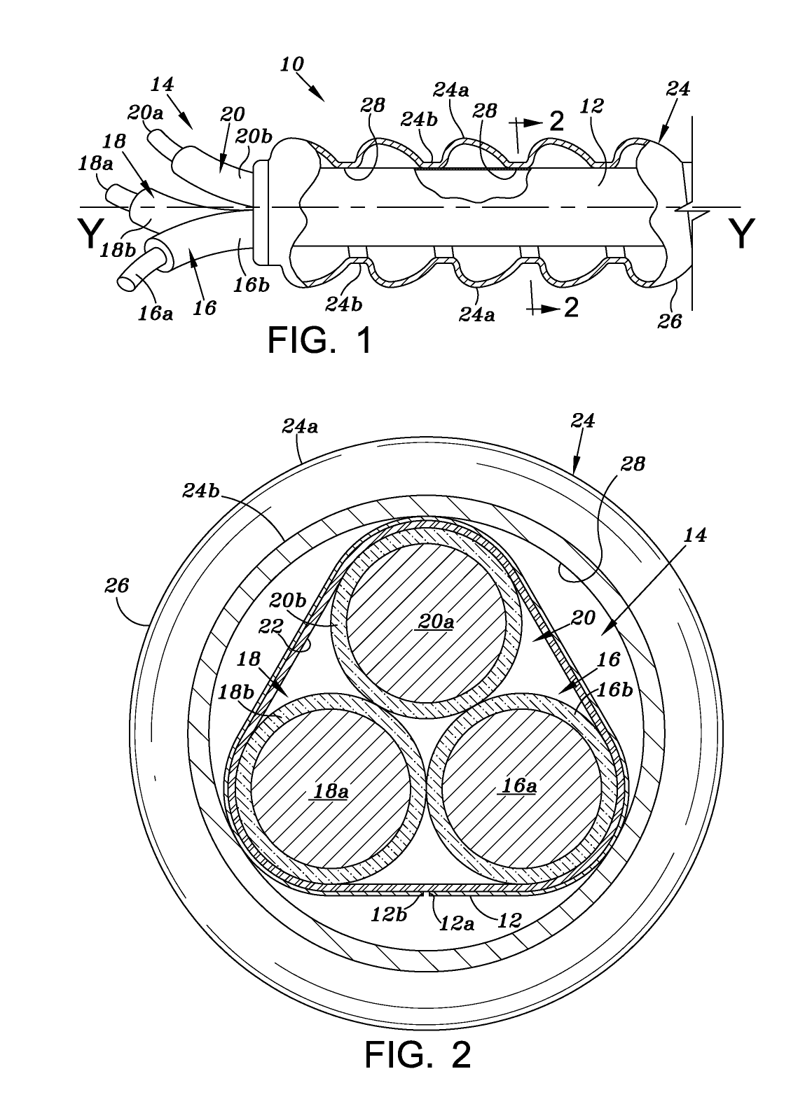

Referring to FIGS. 1 and 2, an embodiment of a metal-clad cable assembly 10 is illustrated in which an electrically conductive grounding foil 12 is employed to advantage. In FIGS. 1 and 2, grounding foil 12 is disposed over a conductor assembly 14, the conductor assembly comprising three conductors 16, 18 and 20 disposed within a binder 22 (FIG. 2). For purposes herein, grounding foil 12 can include any type of conductive sheet or layer disposed over conductor assembly 14. In the embodiment illustrated in FIGS. 1 and 2, conductors 16, 18 and 20 are formed of metallic wires 16a, 18a and 20a disposed within polymeric insulation or polymeric jackets 16b, 18b and 20b. It should be understood that while three conductors 16, 18 and 20 are illustrated, a greater or fewer number of conductors may be utilized, depending on the particular application of the metal-clad cable assembly 10. In the embodiment illustrated in FIGS. 1 and 2, binder 22 extends the longitudinal length Y-Y of cable assembly 10 and is of a sufficient resiliency to hold and otherwise prevent relative movement between conductors 16, 18 and 20 while also serving as a protective layer to prevent and/or substantially resist damage thereto.

In the embodiment illustrated in FIGS. 1 and 2, grounding foil 12 and conductor assembly 14 are disposed within an outer metal sheath 24 such that grounding foil 12 contacts metal sheath 24 to provide a low impedance ground path having an ohmic resistance equal to or lower than the ohmic resistance requirements necessary to qualify as an equipment grounding conductor under, for example, Underwriters Laboratory Standard for Safety for Metal-Clad Cables UL 1569 (hereinafter “UL 1569”). Metal sheath 24 is formed of a metal strip having overlapping and interlocking adjacent helical convolutions, an example of which is described in U.S. Pat. No. 6,906,264, assigned to the assignee of the present invention, the disclosure of which is incorporated by reference herein. For example, as best illustrated in FIG. 1, metal sheath 24 is formed of a metal strip such as, for example, aluminum, having convolutions that overlap or interlock with uniformly spaced “crowns” 24a and “valleys” 24b defining an outer surface 26 of the sheath 24. However, it should be understood that metal sheath 24 may be otherwise configured, such as, for example, a solid or non-interlocked metallic covering.

The foil configuration described herein is advantageous in metal clad cables that typically utilize a bare grounding conductor cabled within an interstice formed by the conductor assembly, such as that disclosed in U.S. Pat. No. 6,486,395, assigned to the assignee of the present invention, the disclosure of which is incorporated by reference herein. In particular, the foil configuration disclosed herein is advantageous in configurations in which a bare grounding conductor comprises a larger diameter relative to the diameter of the conductors in the conductor assembly. When such configurations exist, the grounding conductor oftentimes lifts outward or is otherwise displaced from within the interstice during manufacturing, especially during the cabling process. Accordingly, when the metal sheath is subsequently applied around the conductor assembly having a bare grounding conductor lifted outward from or misaligned with the interstice, the sheath can push the bare grounding conductor against the binder in an unwanted fashion, potentially damaging the binder and insulation 16b, 18b and 20b or respective conductors 16, 18 and/or 20. This can result in dielectric failure ultimately rendering the cable useless. Accordingly, by utilizing a foil 12 having a generally planar profile like that described herein, such disadvantages can be avoided. Furthermore, embodiments described herein are advantageous as a result of the reduced thickness of grounding foil 12, which enables an installer to more easily terminate the cable without requiring additional cutting force while also reducing sharp edges of the terminated portion.

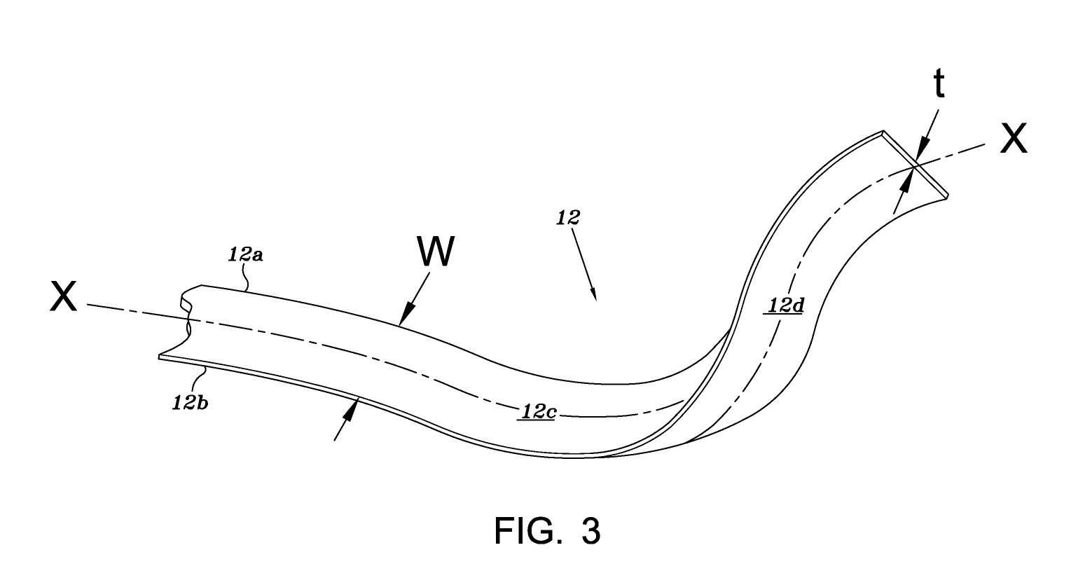

Referring to FIG. 3, grounding foil 12 is formed of a flexible sheet-like material defined by edge 12a, edge 12b and top and bottom planar surfaces 12c and 12d, respectively, having a predetermined width “W” and thickness “t”. As seen in FIG. 3, grounding foil 12 is a continuous strip extending along a longitudinal axis X-X. Grounding foil 12 is preferably formed of a metallic material, such as, but not limited to, aluminum or copper; however, grounding foil 12 may alternatively be formed of any other suitable conductive and flexible material. Thickness t and width W are sized so that the cross sectional area of grounding foil 12 is sufficiently sized to act as a grounding conductor when in contact with an interior surface 28 of valleys 24b of the metal sheath 24 (best illustrated in FIGS. 1, 2, 4 and 5) such that the sheath 24, in combination with grounding foil 12, are sufficient to provide the low impedance ground path. As an example, the thickness “t” is approximately 3-4 mils and width “W” is approximately 1 inch.

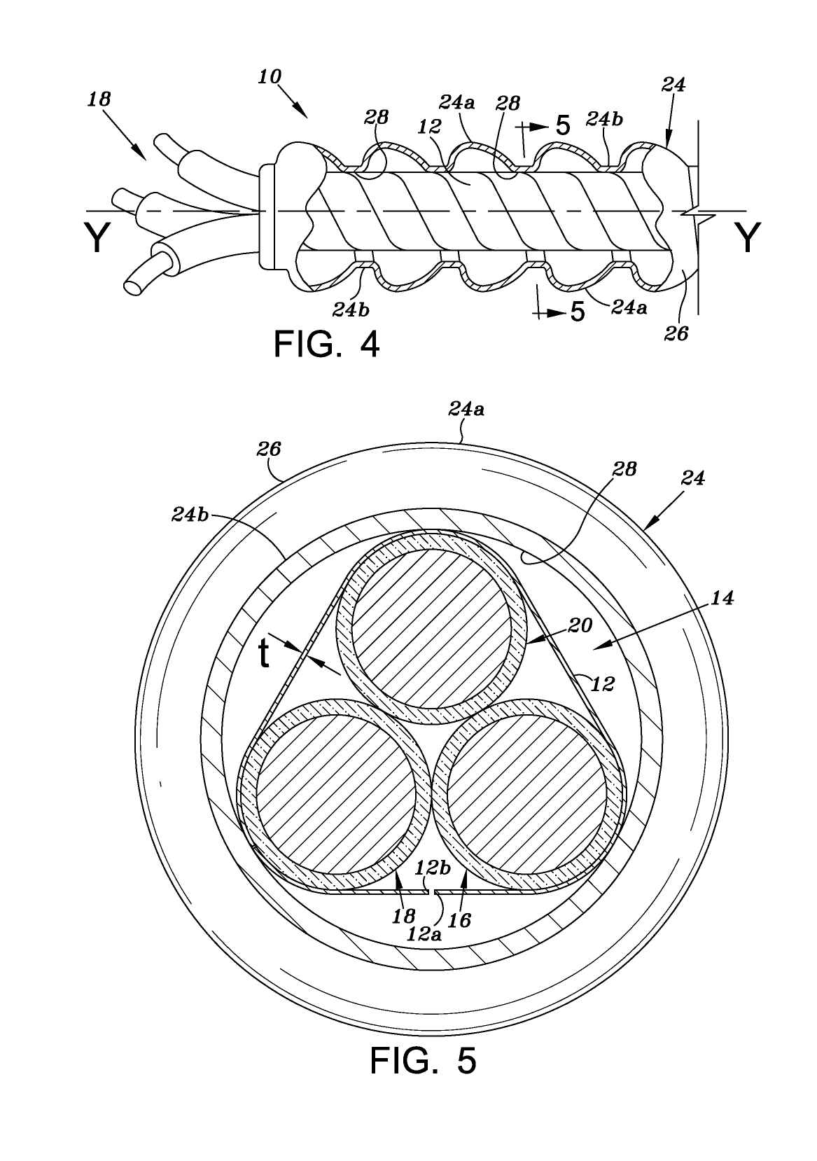

According to some embodiments, grounding foil 12 is sized to enclose all or a portion of conductor assembly 14, depending on the particular application and rating requirements for metal clad cable assembly 10. For example, in FIGS. 1 and 2, foil 12 is oriented around conductor assembly 14 such that the longitudinal axis X of foil 12 is parallel and aligned with the longitudinal axis Y of metal clad cable 10 (FIG. 1) so that edges 12a and 12b can be wrapped around conductor assembly 14. As illustrated in FIG. 2, foil 12 is wrapped around conductor assembly 14 and positioned either so that the edges 12a and 12b overlap or are spaced apart depending on how many conductors are contained within conductor assembly 14. For example, grounding foil 12 may extend only partially around conductor assembly 14 (i.e., having a gap between edges 12a and 12b as a result of, for example, a large number of conductors within the conductor assembly) or, alternatively, grounding foil 14 may be positioned so that edge 12a overlaps edge 12b to fully enclose conductor assembly 14. In addition, grounding foil 12 may be wrapped in successive layers around conductor assembly 14. Alternatively, grounding foil 12 may be helically applied to enclose the conductor assembly 14, as illustrated in FIG. 4.

FIG. 5 is an illustration of an alternate embodiment similar to the embodiment illustrated in FIGS. 1 and 2 with binder 22 removed and grounding foil 12 directly enclosing or otherwise covering conductor assembly 14. Grounding foil 12 is sized such that it acts in concert with metal sheath 24 while also having a suitable thickness “t” to protect conductors 16, 18 and 20 when binder 22 is absent from conductor assembly 14.

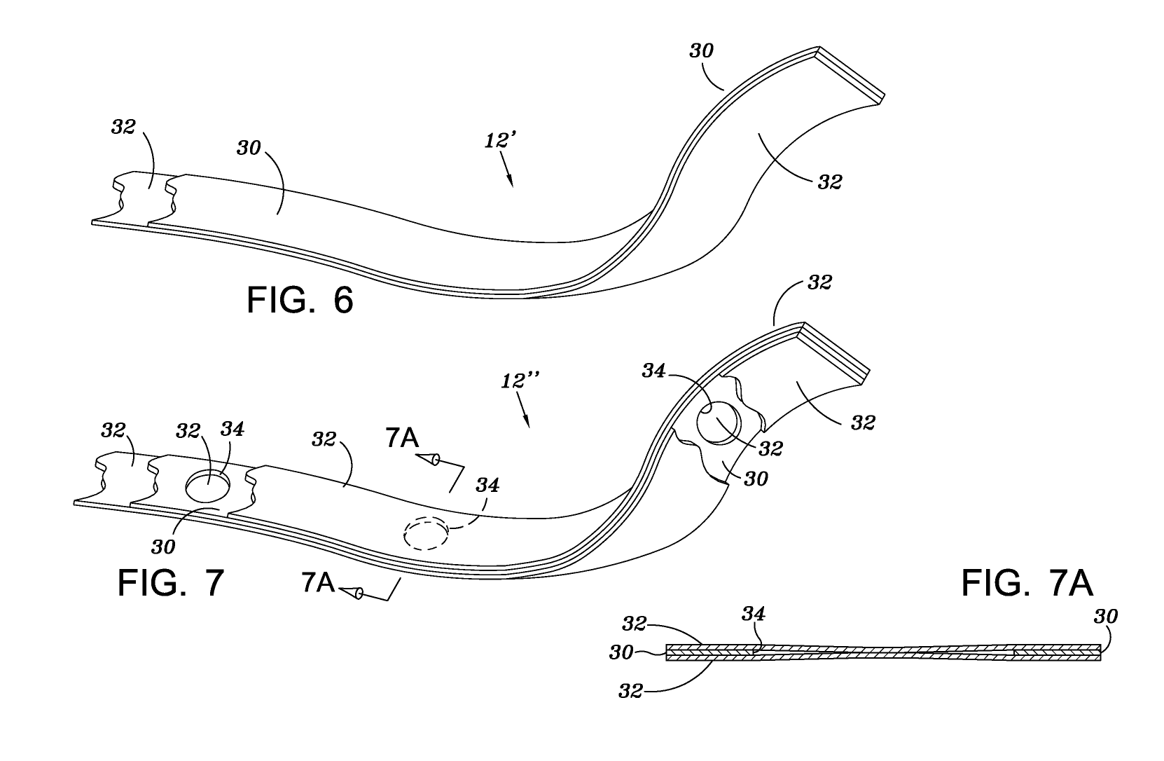

Referring now to FIG. 6, an alternate embodiment of a grounding foil is illustrated. For example, FIG. 6 illustrates a reinforced grounding foil 12′ having a reinforcing member 30 affixed to a conductive layer 32 by an adhesive material, the reinforcing member 30 providing additional strength and support for conductive layer 32. In the embodiment illustrated in FIG. 6, conductive layer 32 may comprise any type of conductive material, such as an aluminum tape/foil, a copper tape/foil or the like. Similarly, reinforcing member 30 can be formed of any conductive or non-conductive material having sufficient strength and support characteristics, such as, for example, a material formed of a polyester film. In one embodiment, reinforcing member 30 is formed of a biaxially-oriented polyethylene terephthalate material, sold under the trademark MYLAR®.

Referring specifically to FIGS. 7 and 7A, another embodiment of a grounding foil is illustrated. For example, FIGS. 7 and 7A illustrate a reinforced grounding foil 12″ having reinforcing member 30 disposed between conductive layers 32 to provide additional strength and/or support to conductive layers 32. As illustrated in FIGS. 7 and 7A, reinforcing member 30 includes spaced apart openings 34 to enable contact between layers 32 (best seen in FIG. 7A) thereby facilitating an electrically conductive path between respective layers 32. This configuration enables both conductive layers 32 to act in concert with metal sheath 24 to form the desired ground path. Further, a separate conductive layer 32 is disposed on both sides of reinforcing member 30 so that in the event that foil 12″ becomes twisted while being wrapped around conductor assembly 14, electrical conductivity between metal sheath 24 and grounding foil 12″ remains uncompromised.

In the embodiment illustrated in FIGS. 7 and 7A, spaced apart openings 34 are circular; however, it should be understood that other configurations may be used (i.e., oval, rectangular, longitudinal slots, etc.). Furthermore, a greater or fewer number of opening may also be utilized depending on the particular application in which cable assembly 10 is utilized. Furthermore, while FIGS. 6-7A illustrate that reinforcing member 30 is a separate layer and coupled to conductive layers 32, it should be understood that reinforcing member 30 can be otherwise configured. For example, according to some embodiments, reinforcing member 30 could be woven into a conductive layer 32 and/or formed integral with a conductive layer 32.

When cabling the conductors 16, 18 and 20, each conductor is fed through a separate positioning hole in a lay plate or other device. Conductors 16, 18 and 20 are then pulled together through an orifice into either a twisted or non-twisted bundle, depending on the desired configuration. Binder 22 is then applied around the conductor bundle to complete conductor assembly 14. The grounding foil 12, 12′ or 12″ is normally applied around conductor assembly 14 during the cabling process; however, it should also be understood that such grounding foil may be applied around the conductor assembly 14 after cabling and prior to and/or simultaneously during the armoring process, when metal sheath 24 is formed.

For example, metal sheath 24 may be formed by using an armoring machine to helically wind a metal strip around conductor assembly 14 and grounding foil 12, 12′ or 12″. The edges of the helically wrapped metal sheath 24 interlock to form convolutions along the length of cable 10. The inside perimeter of metal sheath 24 is sufficiently sized so that the foil engages the inner curves or “valleys” 24b of convolutions in metal sheath 24 to form the low impedance ground path. Thus, construction of the cable assembly 10 in accordance with the described embodiments of the foil enables contact between the foil and the interior surface 28 of metal sheath 24 along the longitudinal length of cable assembly 10, thus maximizing the use of metal sheath 24 as a low impedance ground path with increased reliability. It should be understood that manufacturing steps can be combined or executed simultaneously in a continuous manner and in any order.

Although embodiments of the metal clad cable assembly 10 have been described in detail, those skilled in the art will also recognize that various substitutions and modifications may be made without departing from the scope and spirit of the appended claims.

What is claimed is:

1. A metal-clad cable assembly, comprising:
a conductor assembly having at a plurality of insulated conductors and a binder disposed around the insulated conductors;
an outer metal sheath disposed around the conductor assembly; and
an electrically conductive grounding foil disposed externally to the conductor assembly, the grounding foil comprising a top planar surface and a bottom planar surface, the bottom planar surface engaging the binder and the top planar surface engaging an interior surface of the metal sheath, the metal sheath and grounding foil forming an equipment ground path.

2. The metal-clad cable assembly of claim 1, wherein the grounding foil comprises a first edge and a second edge, the grounding foil wrapped around the conductor assembly such that the first and second edges are disposed adjacent each other.

3. The metal-clad cable assembly of claim 1, wherein the grounding foil partially encloses the conductor assembly.

4. The metal-clad cable assembly of Claim1, wherein the grounding foil comprises a thickness of between 3-4 mils.

5. The metal-clad cable assembly of claim 4, wherein the grounding foil comprises a width of at least 1 inch.

6. The metal-clad cable assembly of claim 1, wherein the conductors are insulated.

7. The metal-clad cable assembly of claim 1, wherein the grounding foil is aluminum.

8. The metal-clad cable assembly of claim 1, wherein the grounding foil is copper.

9. The metal-clad cable assembly of claim 1, wherein the grounding foil has a longitudinal axis extending parallel to a longitudinal axis of the metal-clad cable assembly.

10. The metal-clad cable assembly of claim 1, wherein the grounding foil is helically disposed around the conductor assembly.

11. A method of manufacturing a metal-clad cable assembly, comprising:
placing a binder around a plurality of conductors to form a conductor assembly;
covering the conductor assembly with an electrically conductive grounding foil having a top planar surface and a bottom planar surface; and
placing a metal sheath around the conductive grounding foil such that an inner surface of the metal sheath contacts the top planar surface of the grounding foil, the foil and metal sheath forming a low impedance ground path.

12. The method of claim 11, wherein covering the conductor assembly with the grounding foil comprises wrapping the conductor assembly with the grounding foil such that respective the first and second edges of the foil are disposed adjacent each other.

13. The method of claim 11, wherein covering the conductor assembly with the electrically conductive grounding foil comprises at least partially wrapping the conductor assembly with the grounding foil.

14. The method of claim 11, further comprising forming the foil having a thickness of between 3-4 mils.

15. The method of claim 11, further comprising forming the grounding foil of aluminum.

16. The method of claim 11, further comprising forming the grounding foil of copper.

17. The method of claim 11, further comprising orienting a longitudinal axis of the grounding foil parallel to a longitudinal axis of the cable assembly.

18. The method of claim 11, further comprising helically wrapping the grounding foil around the conductor assembly.

19. The method of claim 11, further comprising coupling a reinforcing member to the grounding foil.

20. The method of claim 11, further comprising forming the foil having a width of at least 1 inch.

21. A metal-clad cable assembly, comprising:
a conductor assembly having a plurality of insulated conductors;
an outer metal sheath disposed around the conductor assembly; and
an electrically conductive sheet disposed between the outer metal sheath and the conductor assembly, the electrically conductive sheet at least partially enclosing the conductor assembly, the conductive sheet comprising a top planar surface and a bottom planar surface having a thickness, the conductive sheet and outer metal sheath configured to provide a low impedance equipment grounding path.

22. The metal-clad cable assembly of claim 21, further comprising a binder disposed around the plurality of insulated conductors.

23. The metal-clad cable assembly of claim 22, wherein the bottom planar surface engages the binder and the top planar surface engages an interior surface of the metal sheath to form the low impedance equipment ground path.

24. The metal-clad cable assembly of claim 21, further comprising a reinforcing member coupled to the bottom planar surface of the electrically conductive sheet.

25. The metal-clad cable assembly of claim 24, wherein the reinforcing member is disposed between a pair of electrically conductive sheets.

26. The metal-clad cable assembly of claim 25, wherein the reinforcing member comprises an opening to facilitate electrical contact between the pair electrically conductive sheets.
